(19) United States
(12) Patent Application Publication
(10) Pub. No.: US 2024/0012185 A1
(43) Pub. Date: Jan. 11, 2024

(54) HIDDEN DISPLAY SYSTEM

(71) Applicant: Clarion Corporation of America, Auburn Hills, MI (US)

(72) Inventors: Young G. HONG, Rochester Hills, MI (US); Isabelle MELSCOET, Chantilly (FR)

(21) Appl. No.: 17/859,227

(22) Filed: Jul. 7, 2022

(51) Int. Cl. G02B 5/02

(52) U.S. Cl. CPC G02B 5/0252; G02B 5/0221

(57) ABSTRACT

A hidden display system uses a light shaping diffuser to limit the effects of scattering and interference, in particular Moire patterns, created when light projected from a display is projected through a display hiding layer. The hidden display system has an active mode and an inactive mode, wherein an observer sees only the display hiding layer in an inactive mode.

### BACKGROUND

The present disclosure relates to display systems and configurations, and particularly to display systems and configurations that remain hidden while in an inactive state. More particularly, the present disclosure relates to hidden display systems that use a light-shaping diffuser.

### SUMMARY

According to the present disclosure, at least some embodiments of a hidden display system comprise a display, a light shaping diffuser, a display hiding layer, and a cover lens. The light shaping diffuser is located between the display and the display hiding layer.

In other or the same embodiments, a hidden display system comprises a display, a light shaping diffuser, a display hiding layer, and a light shaping diffuser. The display projects an image made up of pixels, and the light shaping diffuser reduces the number of pixels that are altered due to an optical interference effect between the image projected by the display and the display hiding layer.

In at least some illustrative embodiments, a hidden display system comprises a display, a light shaping diffuser, a display hiding layer, and a cover lens. According to at least some illustrated embodiments, a display is located beneath the light shaping diffuser, the light shaping diffuser is located beneath the display hiding layer, and the display hiding layer is located beneath the cover lens.

According to some embodiments the light shaping diffuser is a holographic surface or a randomized micro lens array. According to some embodiments the display hiding layer comprises a perforated black layer and surface having physical indicia. The perforated black layer can comprise a plurality of spaced-apart apertures that have a generally uniform aperture size across the plane of the perforated black layer, and the plurality of apertures can be generally spaced apart from one another at a distance, with that generally uniform aperture size in one dimension being between about 0.025 mm and about 0.1 mm.

In some embodiments the display has both an active and an inactive mode. In an inactive mode, light reflected from the hidden display system projects an image of a surface, often having physical indicia. When the display is in an active mode, light reflected from the hidden display system projects an image of the surface, and further an image that is projected by the display.

According to some embodiments a light shaping diffuser reduces a Moire interference effect between the image projected by the display and the display hiding layer, and in at least some embodiments this diffuser has a FWHM angle of about 20 degrees or less.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1A is a schematic diagram showing a comparative hidden display in an inactive mode;

FIG. 1B is a schematic diagram showing a comparative hidden display in an active mode;

FIG. 2A is a schematic diagram showing a hidden display system in an inactive mode according to at least one embodiment of the present disclosure;

FIG. 2B is a schematic diagram showing a hidden display system in an active mode according to at least one embodiment of the present disclosure;

FIG. 3 is a depiction of a mechanism for measuring the diffusion profile of a light emitter;

FIG. 4A is a chart profiling the diffusion profile of a comparative hidden display from a top-down view;

FIG. 4B is a chart profiling the angular luminous flux distribution of the diffusion profile of FIG. 4A;

FIG. 5A is a chart profiling the diffusion profile of a hidden display system having a holographic light shaping diffuser from a top-down view according to at least some embodiments of the present disclosure;

FIG. 5B is a chart profiling the angular luminous flux distribution of the emission profile of FIG. 5A;

FIG. 6A is a chart profiling the diffusion profile of a hidden display system having a randomized micro lens array light shaping diffuser from a top-down view according to at least some embodiments of the present disclosure;

FIG. 6B is a chart profiling the diffusion profile of a hidden display system from a top-down view according to at least some embodiments of the present disclosure;

FIG. 7A is a top-down view showing a hidden display system in an inactive mode according to at least some embodiments of the present disclosure;

FIG. 7B is a top-down view showing a hidden display system in an active mode according to at least some embodiments of the present disclosure;

FIG. 8A is a top-down view showing a comparative display in an active mode;

FIG. 8B is a top-down view showing a hidden display system in an active mode according to at least some embodiments of the present disclosure; and

FIG. 9 depicts a structure of a computer system for optimizing at least some embodiments of the present disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. The features illustrated or described in connection with one exemplary embodiment may be combined with the features of other embodiments. Such modifications and variations are intended to be included within the scope of the present disclosure. Terms commonly known to those skilled in the art may be used interchangeably herein.

The present disclosure provides for systems that mitigate the scattering and interference effects of intermediate layers in hidden displays. These systems act to largely preserve, or otherwise improve, the viewing angle of a hidden display system. Viewers of the embodiments of the hidden display system can view projected images with greater clarity and intensity than those displays currently available in the art.

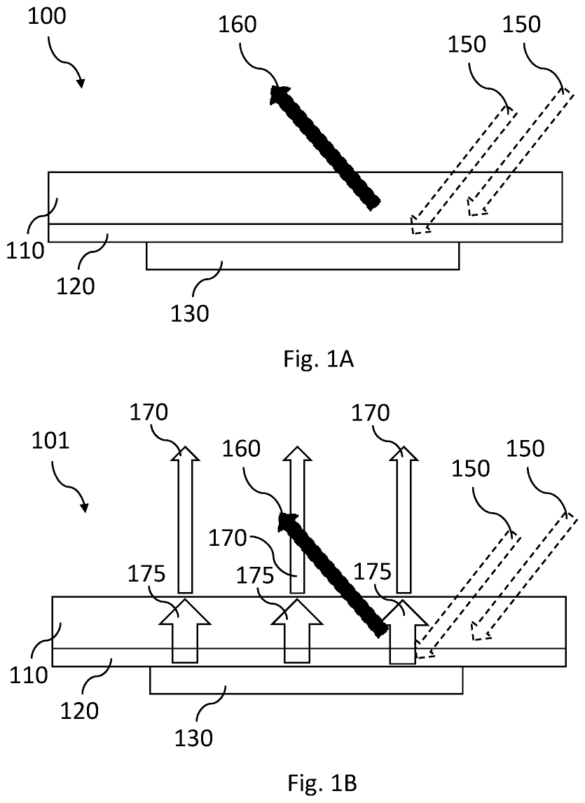

Turning first to FIG. 1A, a schematic diagram shows a comparative hidden display in an inactive mode 100, while FIG. 1B depicts the same comparative hidden display in an active mode 101. The comparative hidden displays 100 and 101 comprise cover lens 110, display hiding layer 120, and display 130. FIG. 1 further depicts ambient light 150, and reflected ambient light 160, which has been reflected from display hiding layer 120. In FIG. 1B, light emitted from the display 130 is depicted as broad arrows 175, while light ultimately emitted from the comparative hidden display in the active mode 101 is depicted using arrows 170. Arrows 175 and 170 indicate only a predominant direction of emitted light, and are not meant to directly represent a distribution of emitted photons.

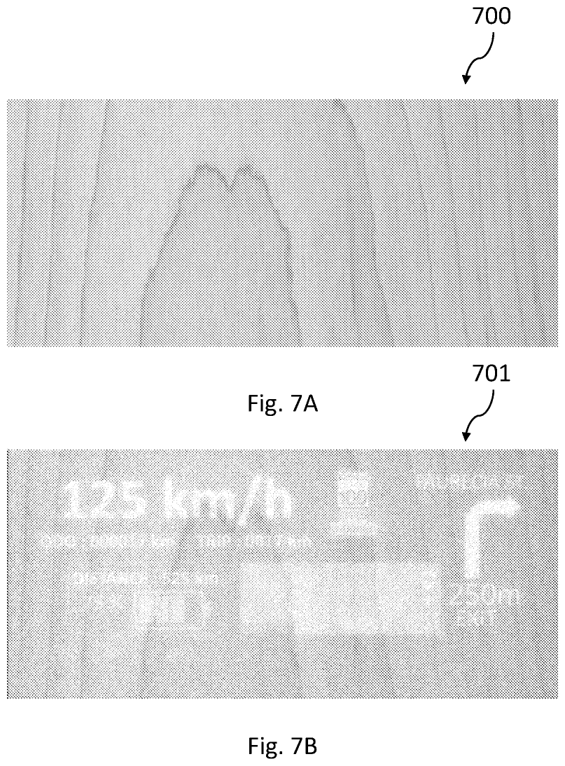

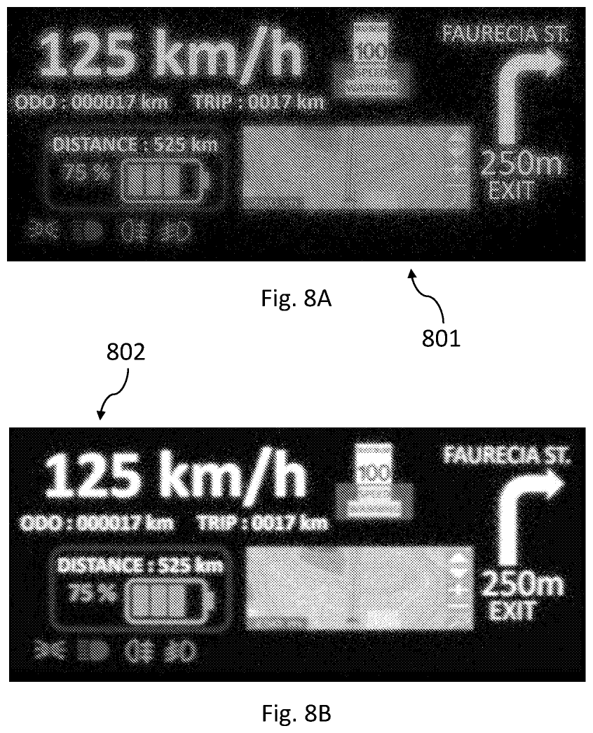

When the display 130 is in an inactive mode 100, no image is projected from display 130, and thus no image can be seen by an observer. Instead, the observer sees only the surface of a display hiding later 120, reflecting ambient light 150. A display hiding layer may have indicia, and such a display hiding layer is depicted in FIG. 7A, depicting an observer's view of the comparative hidden display in an inactive mode 100. When the display 130 is on, rendering the comparative hidden display to an active mode 101, a display image is visible, such as display image 701 of FIG. 7B or display image 801 of FIG. 8A. To achieve this comparative hidden display functionality, the display hiding layer 120 is perforated with periodic perforations, where the display hiding layer 120 is constructed from material such to render it diffusive, translucent, or opaque. In some comparative display hiding layers 120, the layers are perforated, where the typical perforation holes are round and the hole size is between approximately about 0.025 mm to about 0.1 mm in diameter. In some comparative hidden displays, the density or periodicity of the perforation holes depends solely on a target transmission ratio of display hiding layer 120, which is typically between about 20% to about 40%. In a comparative hidden display, the target transmission ratio of display hiding layer 120 depends only on the emissions profile of display 130, with the goal of rendering light emitted to the observer 170 from the display 130 according to a target emitted photon distribution.

Because of the periodic perforations regularly arranged in display hiding layer 120, and a mismatch between this pattern of perforations and a pattern of pixels in display 130, an observer will see a Moire pattern. This Moire effect significantly degrades the quality of the observed image.

In a comparative hidden display system, this Moire pattern can be addressed adding a coating having diffusive properties to the surface of display hiding layer 120, or in some embodiments utilizing a separate diffusive surface. In these embodiments of a comparative hidden display system, a user will observe a degradation of image sharpness and brightness.

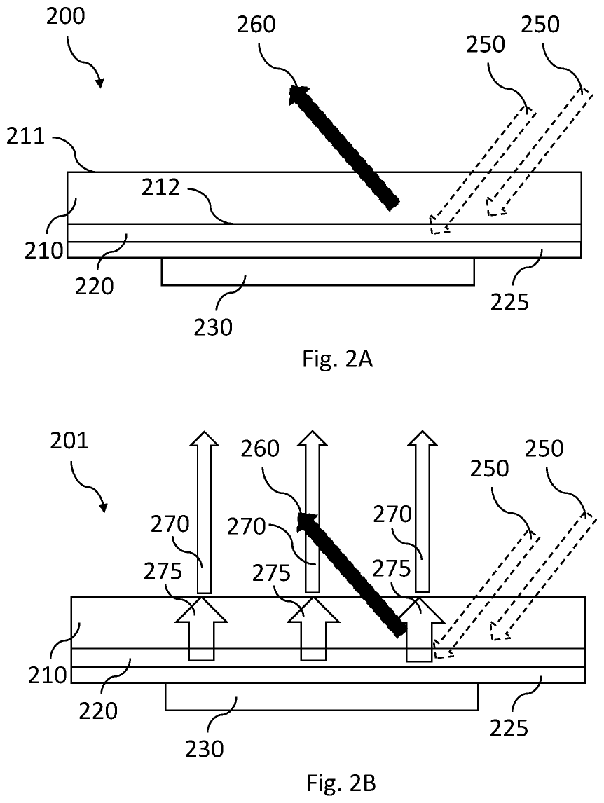

In contrast to FIG. 1, FIG. 2 depict a hidden display system of at least one embodiment in an inactive mode 200 in FIG. 2A and in an active mode 201 in FIG. 2B. The hidden display system of FIG. 2 comprises a cover lens 210 having upper surface 211 and lower surface 212, display hiding layer 220, light shaping diffuser 223, and display 230. FIG. 2 further depict ambient light 250, and reflected ambient light 260, which has been reflected from display hiding layer 220. In FIG. 2B, light emitted from the display 230 is depicted as broad arrows 275, while light ultimately emitted from the hidden display system in the active mode 201 is depicted using arrows 270. Arrows 275 and 270 indicate only a predominant direction of emitted light, and are not meant to directly represent a distribution of emitted photons.

In a hidden display system such as that depicted in FIG. 2, the Moire effect described above is either removed entirely or significantly reduced with minimal reduction in the sharpness and brightness of an image perceived by an observer when hidden display system 201 is in an active mode. According to at least some embodiments, this reduction can be measured according to the number and intensity of pixels altered by a Moire effect.

According to at least some embodiments of the present disclosure, a light shaping diffuser 225 is positioned between the display 230 and the display hiding layer 220. According to at least some embodiments, the light shaping diffuser 225 is a holographic layer. According to other embodiments, the light shaping diffuser 225 is a randomized micro lens array. According to yet other embodiments, the light shaping diffuser 225 is a combination of both a holographic layer and a micro lens array.

According to at least some embodiments, the light shaping diffuser 225 has a light diffusing profile that resembles an ideal Gaussian distribution. In other embodiments, the light shaping diffuser 225 has a diffusing profile that is limited within a field of view angle. In at least some of such embodiments, this results in a decreased hazing effect and better transmission ratio comparing to a comparative diffuser surface.

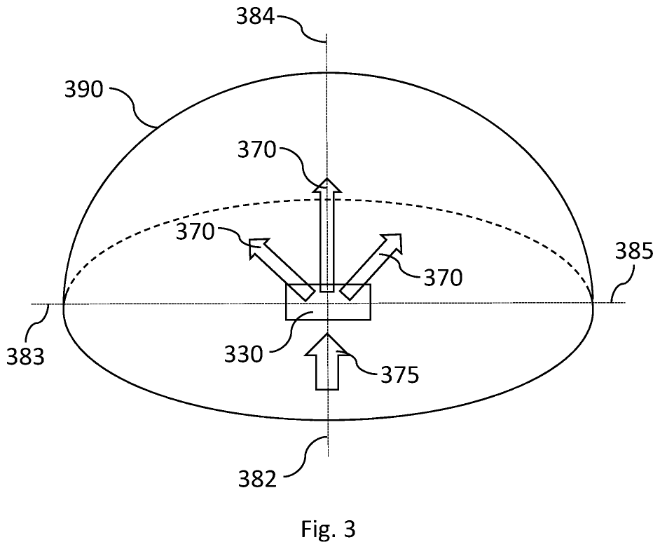

Turning to a discussion of diffusion profiles of a light shaping diffuser, FIG. 3 depicts a mechanism for measuring the diffusion profile of a light source. In the depiction of FIG. 3, the light source is a combination of incident light (which in this example is collimated) and a light shaping diffuser 330, such that diffused light 370 is ultimately measured in intensity by a semi-sphere light intensity sensor 390. In the depiction of FIG. 3, diffused light 370 strikes semi-sphere light intensity sensor 390. The intensity of this diffused light as measured by the semi-sphere light intensity sensor 390 can then be plotted graphically, such as on a negative Y axis 382, positive Y axis 384, negative X axis 383, and positive X axis 385.

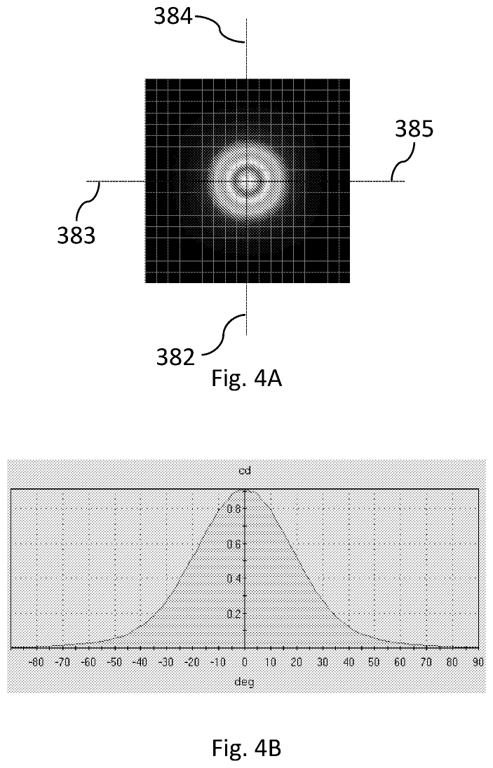

FIG. 4A is a chart depicting the diffusion profile of a comparative hidden display, across the same axis configuration of FIG. 3. FIG. 4B similarly depicts a chart profiling the angular luminous flux distribution of the diffusion profile of FIG. 4A, wherein the distribution of FIG. 4A is profiled along one axis. In this instance, the Full Width at Half Maximum (FWHM) of the plot of FIG. 4B is significantly greater than a 20 degree angle. The comparative diffuser, which is a surface or coating of a display hiding layer such as display hiding layer 120 of FIG. 1 is made by surface roughness induced by surface grinding, chemical etching, or laser etching. Scattering particles inside the comparative diffuser can contribute to the diffusing properties.

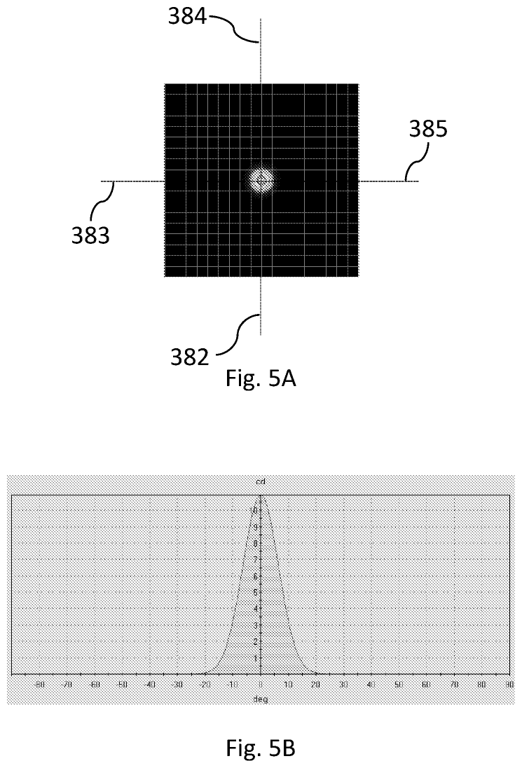

An advantageous embodiment of a hidden display system is depicted in FIG. 5A showing a chart depicting the diffusion profile of a hidden display system, across the same axis configuration of FIG. 3. FIG. 5B similarly depicts a chart profiling the angular luminous flux distribution of the diffusion profile of FIG. 5A, wherein the distribution of FIG. 5A is profiled along one axis. In this instance, the FWHM of the plot of FIG. 5B is less than a 20 degree angle. In the charts of FIG. 5, the hidden display system comprises a holographic light shaping diffuser, such as diffuser 225 of FIG. 2.

According to at least some embodiments, a holographic light shaping diffuser is designed and made by computer generated hologram creation procedure. The typical beam shaping profile of a holographic diffuser according to at least some embodiments of the present disclosure resembles an ideal Gaussian profile. In some embodiments, a Lambertian diffuser is applied in the form of a diffusive film. In other embodiments wherein the diffuser is closer to an ideal Gaussian profile, the Gaussian diffuser can take the form of a ground glass, etched plate, or film form.

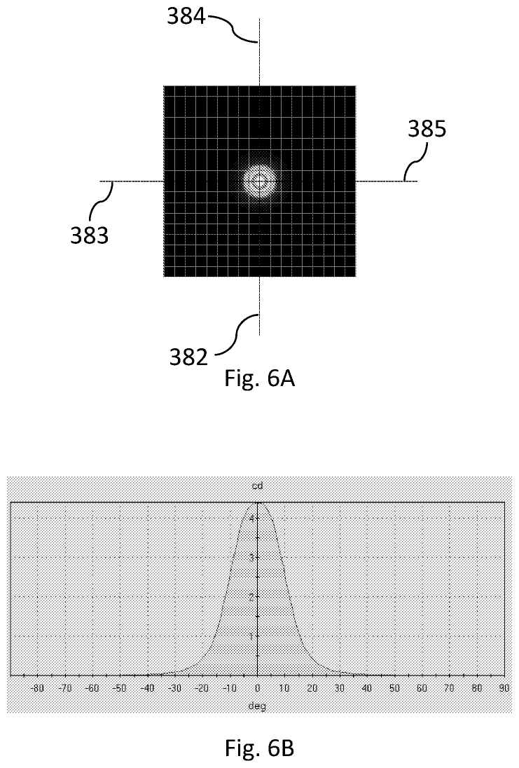

An advantageous embodiment of a hidden display system is depicted in FIG. 6A showing a chart depicting the diffusion profile of a hidden display system, across the same axis configuration of FIG. 3. FIG. 6B similarly depicts a chart profiling the angular luminous flux distribution of the diffusion profile of FIG. 6A, wherein the distribution of FIG. 6A is profiled along one axis. In this instance, the FWHM of the plot of FIG. 6B is less than a 20 degree angle. In the charts of FIG. 6, the hidden display system comprises a micro lens array light shaping diffuser, such as diffuser 225 of FIG. 2.

According to at least some embodiments, the field of view of a display is expressed as the absolute value of the endpoints of a range of degrees from a horizontal projection normal to a display. In other or the same embodiments, the properties of a diffuser are defined, at least in part, by the FWHM angle of the diffuser. In such embodiments, a composite field of view for the hidden display system can be defined as the square root of the sum of the squares of the FWHM angle and the field of view of the display. In an example embodiment, wherein the display has a field of view that is +/−50 degree in horizontal, and the diffuser has a FWHM angle of +/−20 degrees, the composite field of view of the display image is β=\sqrt{20²+50²}=+/−53.85 [degree] in horizontal. When discussing such embodiments, descriptions of the light shaping diffuser FWHM are based on an assumed collimated light incident angle of 0 degrees.

According to at least some embodiment, a light shaping diffuser in a display system covers a display emitting the light with a +/−50 degree in horizontal field of view, and a +/−20 degree in vertical field of view. In some embodiments the display has a luminance level, defined as 25% of the max luminance at perpendicular viewing angle, which is configured for use in automotive displays. In such automotive display embodiments, the field of view of the hidden display system, using a Gaussian light shaping diffuser with 20 degree FWHM diffuser property, is +/−53.85 degree in horizontal, and +/−28.25 degree in vertical.

According to at least some embodiments, a relationship between a light divergent angle of a hidden display system β, a light shaping diffuser FWHM angle Δ, and an incoming light FWHM angle α, is given by β=\sqrt{α²+Δ²}. In such embodiments, the light shaping diffuser FWHM angle Δ is defined as the FWHM angle of diffusion of a collimated light beam after passing through the light shaping diffuser.

According to at least some embodiments, a randomized micro lens array diffuser is designed by a computer generated micro lens array pattern creation procedure. According to at least some embodiments, a beam shaping profile of a randomized micro lens array is between a Gaussian profile and top-hat profile, though in other embodiments this profile resembles an ideal Gaussian or an ideal top-hat profile.

According to at least some embodiments, a cover lens can be crafted from materials including glass such as soda lime and aluminosilicate, plastics or polymers, textiles, or organic materials such as wood. In some embodiments wherein the cover lens comprises indicia, substrates such as glass and plastic can be decorated using different techniques, such as screen-printing, digital printing, holographics, or decorated film either obtained through IML or laminated on a lower surface of the cover lens. In at least some of such embodiments, the lower surface can be textured, or serve as a basis for additional functional layers such as AG, AR, AF, and AM layers. According to other embodiments, lamination of such decorated film can also occur on an upper surface of the cover lens substrate. Decorated cover lenses bearing indicia for hidden display systems can have standard optical layers as well as surface texturing on the upper surface of the cover lens.

According to at least some embodiments, the cover lens can have a transmission between about 20% and about 40%, and a diffusion beneath about 50%, though in some embodiments the diffusion is beneath about 4%. According to at least some embodiments, the upper surface of the cover lens has a reflection beneath about 2.5%. According to some embodiments, and in particular those which have been manufactured using magnetron sputtering techniques, the upper surface of the cover lens has a reflection between about 0.1% and about 0.5%.

In at least some embodiments the cover lens has a gloss unit beneath 70, and in other or the same embodiments a matte finish is used. In at least some embodiments a cover lens has a white black homogeneity drop below about 10%, and minimizes color shift. According to at least some embodiments of a hidden display system as described herein, a LCD display is covered with a diffusive layer, which is further covered by a decorated layer, which is further covered by a glass or plastic base substrate, which is further covered by multiple layers of coatings, including AG, AR, and ETC coatings.

FIG. 7 depicts an image of a display hiding layer 700 when a hidden display system is in an inactive mode. In this mode, wherein the display hiding layer 700 comprises physical indicia resembling a wood-grain look, the display hiding layer 700 has regularly-arranged perforations which are not visible to an observer from a typical distance of observation. According to at least some embodiments, a display hiding layer comprises a perforated layer. In at least some of such embodiments, that perforated layer is a shade of grey or black. In at least some embodiments, the perforated layer is formed to include a plurality of spaced-apart apertures having a generally uniform aperture size across the plane of the perforated layer. According to at least some of such embodiments, the plurality of apertures are generally spaced apart from one another at a uniform distance. According to at least some further embodiments, the generally uniform aperture size is, in one dimension, between about 0.025 mm and about 0.1 mm. According to at least some embodiments, these apertures are circular, ovular, or constructed from N-sided polygons, where N is selected from a group of whole numbers.

According to at least some embodiments, a transmission ratio of a light shaping diffuser is between about 80% and about 90% over the visible light spectrum between about 400 nm and about 800 nm.

According to at least some embodiments, the computer generation of a micro lens array pattern or holographic diffuser pattern can be implemented on a computer readable medium can include a central processing unit (CPU), memory, and/or support circuits (or I/O), among other features. In embodiments having a memory, that memory can be connected to the CPU, and may be one or more of a readily available memory, such as a read-only memory (ROM), a random access memory (RAM), floppy disk, hard disk, cloud-based storage, or any other form of digital storage, local or remote. Software instructions, algorithms, and data can be coded and stored within the memory for instructing the CPU. Support circuits can also be connected to the CPU for supporting the processor in a suitable manner. The support circuits may include cache, power supplies, clock circuits, input/output circuitry, and/or subsystems, and the like. These tasks can be further optimized by leveraging a graphics processing unit (GPU).

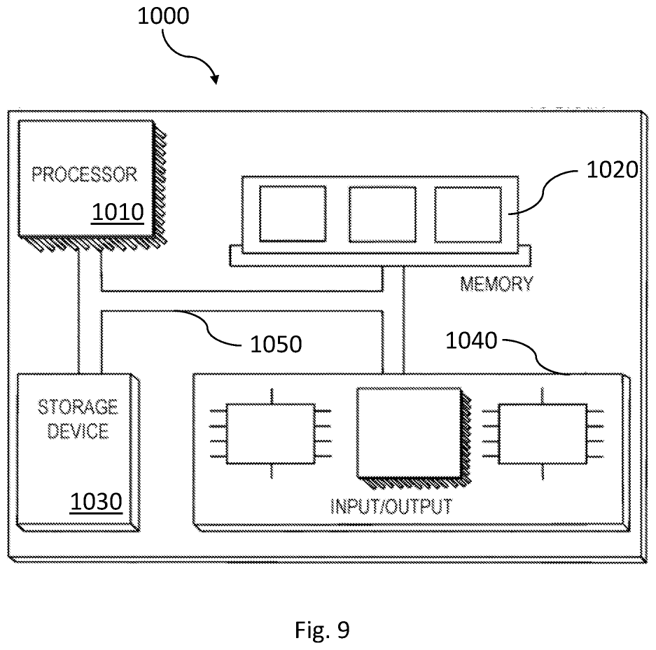

FIG. 9 provides for one non-limiting example of a computer system 1000 for performing actions provided for in the present disclosure, including but not limited to the computer generation of a micro lens array pattern or holographic diffuser pattern. The system 1000 can include a processor 1010, a memory 1020, a storage device 1030, and an input/output device 1040. Each of the components 1010, 1020, 1030, and 1040 can be interconnected, for example, using a system bus 1050. The processor 1010 can be capable of processing instructions for execution within the system 1000. The processor 1010 can be a single-threaded processor, a multi-threaded processor, or similar device. The processor 1010 can be capable of processing instructions stored in the memory 1020 or on the storage device 1030.

The memory 1020 can store information within the system 1000. In some implementations, the memory 1020 can be a computer-readable medium. The memory 1020 can, for example, be a volatile memory unit or a non-volatile memory unit. In some implementations, the memory 1020 can store information related to the instructions for manufacturing light diffusing layers, among other information.

The storage device 1030 can be capable of providing mass storage for the system 1000. In some implementations, the storage device 1030 can be a non-transitory computer-readable medium. The storage device 1030 can include, for example, a hard disk device, an optical disk device, a solid-date drive, a flash drive, magnetic tape, or some other large capacity storage device. The storage device 1030 may alternatively be a cloud storage device, e.g., a logical storage device including multiple physical storage devices distributed on a network and accessed using a network. In some implementations, the information stored on the memory 1020 can also or instead be stored on the storage device 1030.

The input/output device 1040 can provide input/output operations for the system 1000. In some implementations, the input/output device 1040 can include one or more of network interface devices (e.g., an Ethernet card), a serial communication device (e.g., an RS-232 10 port), and/or a wireless interface device (e.g., a short-range wireless communication device, an 802.11 card, a 3G wireless modem, a 4G wireless modem, or a 5G wireless modem). In some implementations, the input/output device 1040 can include driver devices configured to receive input data and send output data to other input/output devices, e.g., a keyboard, a printer, and display devices. In some implementations, mobile computing devices, mobile communication devices, and other devices can be used.

In some implementations, the system 1000 can be a microcontroller. A microcontroller is a device that contains multiple elements of a computer system in a single electronics package. For example, the single electronics package could contain the processor 1010, the memory 1020, the storage device 1030, and input/output devices 1040. The present disclosure also accounts for providing a non-transient computer readable medium capable of storing instructions.

Display systems generally operate by directing photons in the direction of a viewer, such that the viewer's eyes receive an image. In most modern display systems, the meets and bounds of those images are described as projected pixels, where those pixels operate as evenly-distributed, homogenous, tessellated projectors capable of projecting both colors (or shades in the event of black and white displays) and intensities. In most modern displays, these pixels operate as squares, and these squares are tessellated into grids. By adjusting the color and intensity of each pixel, an operator of the display can change the image projected by the display. Common arrays of pixels to form images in present-day displays include 720p (1280×720 pixels), 1080p (1920×1080 pixels), 1440p or “2k” (2560×1440 pixels), and 2160p or “4k” (3840×2160 pixels).

In many theoretical exercises, a display system is treated as homogeneous (the same emission intensity in all locations) and isotropic (the same intensity in all directions). In practice, this is untrue, resulting in many commercial displays such as televisions having classifications of “viewing angle”, denoting an angular range relative to the normal of the display plane from which a typical observer would still experience a relatively ideal picture quality. In such displays, photons emitted by the display are meant to approach an isotropic norm, such that each pixel emits as uniformly in all directions forward of the display as possible. Angles outside of the ideal viewing angle, where observers view blurred images, with lower intensity and contrast, which are more susceptible to interference patterns, are referred to as “off-angles”.

In some embodiments of comparative displays, these systems are designed to be hidden until such time as they are activated. Examples of hidden displays include those which are contained within mirrors, surfaces of tables, and other objects such that an observer would not be able to acknowledge the display immediately upon looking at the object. While an observer may be able to distinguish a section of the mirror, table, or other object, that appears to have a separate surface texture where the display is located, the display would not present itself to the observer as a standard screen. Due to the nature of hidden displays, which have an intermediate layer between the display and the observer that scatters photons emitted by the display, observers often experience effects when viewing hidden displays from all angles as though they are viewing an uncovered display from outside the ideal viewing angle.

Accordingly, the present disclosure provides for a hidden display that minimizes or counteracts the scattering and interference effects of intermediate layers in hidden displays such that viewers relatively normal to those displays can view projected images with greater clarity and intensity than comparative displays.

The following numbered clauses include embodiments that are contemplated and non-limiting:

Clause 1. A hidden display system comprising: a display.

Clause 2. The hidden display of clause 1, any other suitable clause, or any combination of suitable clauses, further comprising a light shaping diffuser.

Clause 3. The hidden display of clause 2, any other suitable clause, or any combination of suitable clauses, further comprising a display hiding layer.

Clause 4. The hidden display of clause 3, any other suitable clause, or any combination of suitable clauses, further comprising a cover lens.

Clause 5. The hidden display of clause 4, any other suitable clause, or any combination of suitable clauses, wherein the light shaping diffuser is located between the display and the display hiding layer.

Clause 6. The hidden display system of clause 5, any other suitable clause, or any combination of suitable clauses, wherein the light shaping diffuser is a holographic diffuser.

Clause 7. The hidden display system of clause 5, any other suitable clause, or any combination of suitable clauses, wherein the light shaping diffuser is a randomized micro lens array (MLA) diffuser.

Clause 8. The hidden display system of clause 5, any other suitable clause, or any combination of suitable clauses, wherein the display hiding layer comprises a perforated layer.

Clause 9. The hidden display system of clause 5, any other suitable clause, or any combination of suitable clauses, wherein the display hiding layer comprises a surface having physical indicia.

Clause 10. The hidden display system of clause 5, any other suitable clause, or any combination of suitable clauses, wherein the light shaping diffuser is a generally Lambertian diffuser.

Clause 11. The hidden display system of clause 5, any other suitable clause, or any combination of suitable clauses, wherein the light shaping diffuser is a generally Gaussian diffuser.

Clause 12. A hidden display system comprising: a display.

Clause 13. The hidden display of clause 12, any other suitable clause, or any combination of suitable clauses, further comprising a light shaping diffuser.

Clause 14. The hidden display of clause 13, any other suitable clause, or any combination of suitable clauses, further comprising a display hiding layer.

Clause 15. The hidden display of clause 14, any other suitable clause, or any combination of suitable clauses, wherein the light shaping diffuser reduces the number of pixels of an image projected by the display that are altered due to an optical interference effect between the image projected by the display and the display hiding layer.

Clause 16. The hidden display system of clause 15, any other suitable clause, or any combination of suitable clauses, wherein the hidden display system further comprises a cover lens.

Clause 17. The hidden display system of clause 16, any other suitable clause, or any combination of suitable clauses, wherein the display is located beneath the light shaping diffuser, the light shaping diffuser is located beneath the display hiding layer, and the display hiding layer is located beneath the cover lens.

Clause 18. The hidden display system of clause 15, any other suitable clause, or any combination of suitable clauses, wherein the display hiding layer comprises a perforated black layer, the perforated black layer having a plurality of evenly spaced holes.

Clause 19. The hidden display system of clause 18, any other suitable clause, or any combination of suitable clauses, wherein the perforated black layer is formed to include a plurality of spaced-apart apertures having a generally uniform aperture size across the plane of the perforated black layer, the plurality of apertures being generally spaced apart from one another a distance, the generally uniform aperture size in one dimension being between about 0.025 mm and about 0.1 mm.

Clause 20. The hidden display system of clause 15, any other suitable clause, or any combination of suitable clauses, wherein the optical interference effect is a Moire effect.

Clause 21. The hidden display system of clause 14, any other suitable clause, or any combination of suitable clauses, wherein the light shaping diffuser has a diffuser FWHM angle of 20 degrees or less.

Clause 22. The hidden display system of clause 15, any other suitable clause, or any combination of suitable clauses, wherein the light shaping diffuser is a holographic diffuser.

Clause 23. The hidden display system of clause 14, any other suitable clause, or any combination of suitable clauses, wherein the light shaping diffuser is a micro lens array (MLA) diffuser.

Clause 24. The hidden display system of clause 23, wherein the MLA is randomized.

Clause 25. The hidden display system of clause 15, any other suitable clause, or any combination of suitable clauses, wherein the display has an active and an inactive mode, and when the display is in an inactive mode, light reflected from the hidden display projects an image of the deco surface.

Clause 26. The hidden display system of clause 25, any other suitable clause, or any combination of suitable clauses, wherein when the display is in an active mode, light reflected from the hidden display projects an image of the deco surface, and an image projected by the display.

Clause 27. A hidden display system comprising: a display.

Clause 28. The hidden display of clause 27, any other suitable clause, or any combination of suitable clauses, further comprising a light shaping diffuser.

Clause 29. The hidden display of clause 28, any other suitable clause, or any combination of suitable clauses, further comprising a display hiding layer.

Clause 30. The hidden display of clause 29, any other suitable clause, or any combination of suitable clauses, further comprising a cover lens.

Clause 31. The hidden display of clause 30, any other suitable clause, or any combination of suitable clauses wherein the display is located beneath the light shaping diffuser, the light shaping diffuser is located beneath the display hiding layer, and the display hiding layer is located beneath the cover lens.

Clause 32. The hidden display of clause 31, any other suitable clause, or any combination of suitable clauses, wherein the light shaping diffuser is selected from the group consisting of a holographic surface and a randomized micro lens array (MLA).

Clause 33. The hidden display of clause 32, any other suitable clause, or any combination of suitable clauses, wherein the display hiding layer comprises a perforated black layer and a surface having physical indicia, wherein the perforated black layer comprising a plurality of spaced-apart apertures having a generally uniform aperture size across the plane of the perforated black layer, the plurality of apertures being generally spaced apart from one another a distance, the generally uniform aperture size in one dimension being between about 0.025 mm and about 0.1 mm.

Clause 34. The hidden display of clause 33, any other suitable clause, or any combination of suitable clauses, wherein the display has an active and an inactive mode.

Clause 35. The hidden display of clause 34, any other suitable clause, or any combination of suitable clauses, wherein, when the display is in an inactive mode, light reflected from the hidden display system projects an image of the surface having physical indicia.

Clause 36. The hidden display of clause 35, any other suitable clause, or any combination of suitable clauses wherein, when the display is in an active mode, light reflected from the hidden display system projects an image of the surface having physical indicia, and an image projected by the display.

Clause 37. The hidden display of clause 36, any other suitable clause, or any combination of suitable clauses, wherein the light shaping diffuser reduces a Moire interference effect between the image projected by the display and the display hiding layer.

Clause 38. The hidden display of clause 37, any other suitable clause, or any combination of suitable clauses, wherein the light shaping diffuser has a diffuser FWHM angle of 20 degrees or less.

1. A hidden display system comprising:
a display;
a light shaping diffuser;
a display hiding layer;
a cover lens;
wherein the light shaping diffuser is located between the display and the display hiding layer.

2. The hidden display system of claim 1, wherein the light shaping diffuser is a holographic diffuser.

3. The hidden display system of claim 1, wherein the light shaping diffuser is a randomized micro lens array (MLA) diffuser.

4. The hidden display system of claim 1, wherein the display hiding layer comprises a perforated layer.

5. The hidden display system of claim 1, wherein the display hiding layer comprises a surface having physical indicia.

6. The hidden display system of claim 1, wherein the light shaping diffuser is a generally Lambertian diffuser.

7. The hidden display system of claim 1, wherein the light shaping diffuser is a generally Gaussian diffuser.

8. A hidden display system comprising:
a display;
a light shaping diffuser;
a display hiding layer;
wherein the light shaping diffuser reduces the number of pixels of an image projected by the display that are altered due to an optical interference effect between the image projected by the display and the display hiding layer.

9. The hidden display system of claim 8, wherein the hidden display system further comprises a cover lens.

10. The hidden display system of claim 9, wherein the display is located beneath the light shaping diffuser, the light shaping diffuser is located beneath the display hiding layer, and the display hiding layer is located beneath the cover lens.

11. The hidden display system of claim 8, wherein the display hiding layer comprises a perforated black layer, the perforated black layer having a plurality of evenly spaced holes.

12. The hidden display system of claim 11, wherein the perforated black layer is formed to include a plurality of spaced-apart apertures having a generally uniform aperture size across the plane of the perforated black layer, the plurality of apertures being generally spaced apart from one another a distance, the generally uniform aperture size in one dimension being between about 0.025 mm and about 0.1 mm.

13. The hidden display system of claim 8, wherein the optical interference effect is a Moire effect.

14. The hidden display system of claim 8, wherein the light shaping diffuser has a diffuser FWHM angle of 20 degrees or less.

15. The hidden display system of claim 8, wherein the light shaping diffuser is a holographic diffuser.

16. The hidden display system of claim 8, wherein the light shaping diffuser is a micro lens array (MLA) diffuser.

17. The hidden display system of claim 16, wherein the MLA is randomized.

18. The hidden display system of claim 8, wherein the display has an active and an inactive mode, and when the display is in an inactive mode, light reflected from the hidden display projects an image of the deco surface.

19. The hidden display system of claim 18, wherein when the display is in an active mode, light reflected from the hidden display projects an image of the deco surface, and an image projected by the display.

20. A hidden display system comprising:
a display;
a light shaping diffuser;
a display hiding layer;
a cover lens;
wherein the display is located beneath the light shaping diffuser, the light shaping diffuser is located beneath the display hiding layer, and the display hiding layer is located beneath the cover lens;
wherein the light shaping diffuser is selected from the group consisting of a holographic surface and a randomized micro lens array (MLA);
wherein the display hiding layer comprises a perforated black layer and a surface having physical indicia, wherein the perforated black layer comprising a plurality of spaced-apart apertures having a generally uniform aperture size across the plane of the perforated black layer, the plurality of apertures being generally spaced apart from one another a distance, the generally uniform aperture size in one dimension being between about 0.025 mm and about 0.1 mm;
wherein the display has an active and an inactive mode;
wherein, when the display is in an inactive mode, light reflected from the hidden display system projects an image of the surface having physical indicia;
wherein, when the display is in an active mode, light reflected from the hidden display system projects an image of the surface having physical indicia, and an image projected by the display;
wherein the light shaping diffuser reduces a Moire interference effect between the image projected by the display and the display hiding layer; and
wherein the light shaping diffuser has a diffuser FWHM angle of 20 degrees or less.
